(19) United States
(12) Patent Application Publication
(10) Pub. No.: US 2012/0314692 A1
(43) Pub. Date: Dec. 13, 2012

(54) METHOD AND APPARATUS FOR PRIORITIZING FEMTO NODE COMMUNICATIONS

(75) Inventors: Peerapol Tinnakornsrisuphap, San Diego, CA (US); David Blanset, San Diego, CA (US); Vikram Gupta, San Diego, CA (US)

(73) Assignee: QUALCOMM Incorporated, San Diego, CA (US)

(21) Appl. No.: 13/315,145

(22) Filed: Dec. 8, 2011

Related U.S. Application Data
(60) Provisional application No. 61/422,055, filed on Dec. 10, 2010.

(51) Int. Cl. H04W 84/02

(52) U.S. Cl. 370/338

(57) ABSTRACT

Methods and apparatuses are provided that include providing switching functionality at a low power base station to allow the low power base station to route communications related to mobile devices and a local area network (LAN) over one or more broadband connections. In this configuration, the low power base station communicates over the one or more broadband connections without traversing the LAN, and can thus implement quality-of-service (QoS) or other parameters for connections from various devices and the LAN. In addition, the low power base station can provide additional switching to route communications between the mobile devices and LAN devices using local internet protocol access.

### CLAIM OF PRIORITY UNDER 35 U.S.C. §119

The present Application for Patent claims priority to Provisional Application No. 61/422,055, entitled “ENABLING TRAFFIC PRIORITIZATION AND LOCAL IP ACCESS FOR FEMTOCELLS” filed Dec. 10, 2010, assigned to the assignee hereof and hereby expressly incorporated by reference herein.

### BACKGROUND

1. Field

The following description relates generally to wireless network communications, and more particularly to femto node implementation.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP) (e.g., 3GPP LTE (Long Term Evolution)/LTE-Advanced), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

To supplement conventional base stations, additional restricted base stations can be deployed to provide more robust wireless coverage to mobile devices. For example, wireless relay stations and low power base stations (e.g., which can be commonly referred to as Home NodeBs or Home eNBs, collectively referred to as H(e)NBs, femto nodes, pico nodes, etc.) can be deployed for incremental capacity growth, richer user experience, in-building or other specific geographic coverage, and/or the like. Such low power base stations can be connected to the Internet via broadband connection (e.g., digital subscriber line (DSL) router, cable or other modem, etc.), which can provide the backhaul link to the mobile operator's network. Thus, for example, the low power base stations can be deployed in user homes to provide mobile network access to one or more devices via the broadband connection. In typical configurations, the low power base station is connected to a router along with one or more other network devices, where the router provides access to the broadband connection. In such configurations, low power base stations may be unable to control quality-of-service (QoS) provided to some connections.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, the present disclosure describes various aspects in connection with providing switching at a low power base station to allow the low power base station to route communications related to mobile devices and a local area network (LAN) over one or more broadband connections. In this configuration, the low power base station communicates over the one or more broadband connections without traversing the LAN, and can thus implement quality-of-service (QoS) or other parameters for connections from various devices and the LAN. In addition, the low power base station can provide additional switching to route communications between the mobile devices and LAN using local internet protocol access.

According to an example, a method of routing network communications is provided. The method includes communicating with a device in a LAN over a LAN communications port and communicating with a wide-area network modem over a modem communications port. The method further includes routing packets between the LAN communications port and the modem communications port through a module over a plurality of virtual LAN (VLAN) ports.

In another aspect, an apparatus for routing network communications is provided. The apparatus includes at least one processor configured to communicate with a device in a LAN over a LAN communications port and communicate with a wide-area network modem over a modem communications port. The at least one processor is further configured to route packets between the LAN communications port and the modem communications port through a module over a plurality of VLAN ports. The apparatus also includes a memory coupled to the at least one processor.

In yet another aspect, an apparatus for routing network communications is provided that includes means for communicating with a device in a LAN over a LAN communications port and means for communicating with a wide-area network modem over a modem communications port. The apparatus further includes means for routing packets between the LAN communications port and the modem communications port through a module over a plurality of VLAN ports.

Still, in another aspect, a computer-program product for routing network communications is provided including a computer-readable medium having code for causing at least one computer to communicate with a device in a LAN over a LAN communications port and code for causing the at least one computer to communicate with a wide-area network modem over a modem communications port. The computer-readable medium further includes code for causing the at least one computer to route packets between the LAN communications port and the modem communications port through a module over a plurality of VLAN ports.

Moreover, in an aspect, an apparatus for routing network communications is provided that includes a LAN communications port for communicating with a device in a LAN and a modem communications port for communicating with a wide-area network modem. The apparatus further includes a switching component for routing packets between the LAN communications port and the modem communications port through a femtocell modem component over a plurality of VLAN ports.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of an example wireless communication system for routing packets.

FIG. 2 is a block diagram of an example wireless communication system for routing packets received from a router through a femtocell modem.

FIG. 3 is a block diagram of an example system for routing packets through a femtocell modem.

FIG. 4 is a flow chart of an aspect of an example methodology for routing mobile device and LAN packets through another module.

FIG. 5 is a flow chart of an aspect of an example methodology for prioritizing packets received from mobile devices and local area network (LAN) devices.

FIG. 6 is a flow chart of an aspect of an example methodology for routing local internet protocol access (LIPA) packets.

FIG. 7 is a flow chart of an aspect of an example methodology for routing LIPA packets to LAN devices.

FIG. 8 is a block diagram of a system in accordance with aspects described herein.

FIG. 9 is a block diagram of an aspect of a system that routes mobile device and LAN packets through another module.

FIG. 10 is a block diagram of an aspect of a wireless communication system in accordance with various aspects set forth herein.

FIG. 11 is a schematic block diagram of an aspect of a wireless network environment that can be employed in conjunction with the various systems and methods described herein.

FIG. 12 illustrates an example wireless communication system, configured to support a number of devices, in which the aspects herein can be implemented.

FIG. 13 is an illustration of an exemplary communication system to enable deployment of femtocells within a network environment.

FIG. 14 illustrates an example of a coverage map having several defined tracking areas.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Described further herein are various considerations related to prioritizing packets for a low power base station, such as a femtocell access point, for communicating over a broadband connection. In one example, where the low power base station is part of a local area network (LAN), it can be coupled to the modem proving a broadband connection without requiring traversal of the LAN, and a router or other LAN component can be coupled to the low power base station for communicating over the broadband connection. For example, the low power base station can include a port for communicating over the broadband connection (e.g., to one or more components of an internet service provider (ISP), such as a modem or similar component), and at least one other port for LAN communications. Thus, for example, the low power base station can route packets from LAN devices over the broadband connection while ensuring certain packets from one or more mobile devices communicating with the low power base station are prioritized over those of the LAN devices. For example, where the low power base station receives circuit switched voice frames or voice over internet protocol (VoIP) or other data packets from a mobile device associated with a certain level of quality-of-service (QoS), the low power base station can prioritize these packets over other packets from LAN devices intended for communication over the broadband connection at least to provide the QoS. In another example, the low power base station can drop packets received from the broadband connection for the LAN devices, which can reduce queuing, to improve latency and/or throughput for the one or more mobile devices. Though referred to generally herein as VoIP, it is to be appreciated that other voice data can be used as well, such as circuit switched voice frames, and/or the like.

A low power base station, as referenced herein, can include a femto node, a pico node, micro node, home Node B or home evolved Node B (H(e)NB), relay, and/or other low power base stations, and can be referred to herein using one of these terms, though use of these terms is intended to generally encompass low power base stations. For example, a low power base station transmits at a relatively low power as compared to a macro base station associated with a wireless wide area network (WWAN). As such, the coverage area of the low power base station can be substantially smaller than the coverage area of a macro base station.

As used in this application, the terms “component,” “module,” “system” and the like are intended to include a computer-related entity, such as but not limited to hardware, firmware, a combination of hardware and software, software, or software in execution, etc. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE), etc. A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, a tablet, a smart book, a netbook, or other processing devices connected to a wireless modem, etc. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE/LTE-Advanced and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

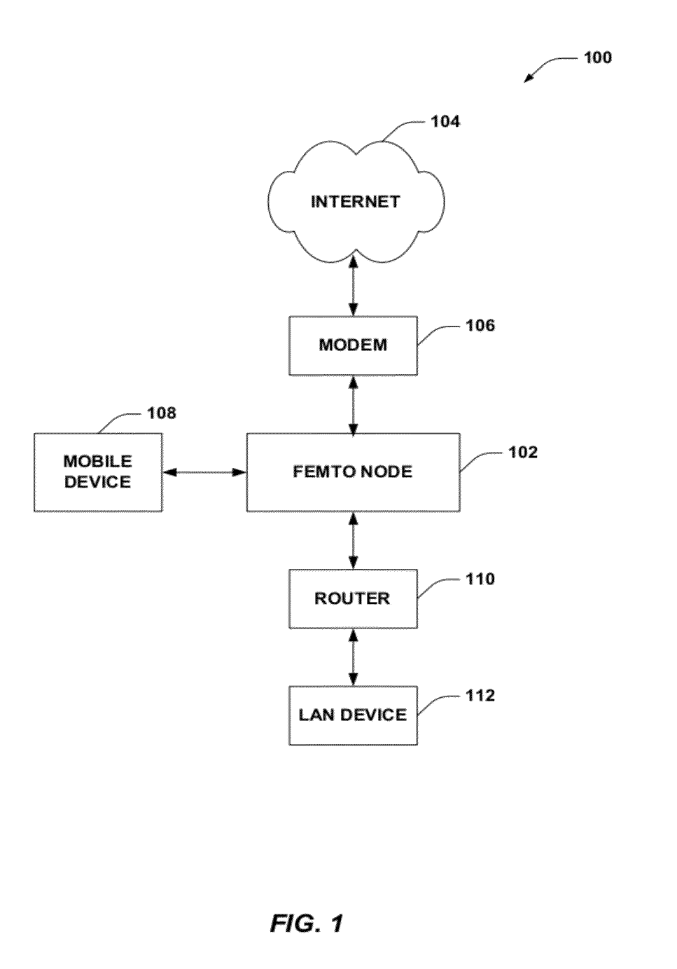

Referring to FIG. 1, a wireless communication system 100 is illustrated that facilitates prioritizing communications from one or more mobile devices. System 100 can include a femto node 102 that provides one or more devices with access to an internet 104. For example, femto node 102 can communicate with a modem 106 to receive access to internet 104. Femto node 102 also communicates with a mobile device 108 to provide internet 104 access thereto. In addition, femto node 102 can communicate with a router 110 to similarly provide internet 104 access thereto, and the router 110 can similarly provide internet 104 access to a device 112. Though shown and described as access to internet 104, it is to be appreciated that femto node 102 can connect to substantially any broadband connection through one or more nodes such to control access for mobile device(s) 108 and network devices (including router 110, device 112, or other devices).

In one example, femto node 102, as described, can be substantially any low power base station, such as a H(e)NB, pico node, micro node, etc. that provides mobile devices, such as mobile device 108, with mobile network services via internet 104. In addition, modem 106 can be a DSL, cable, T1, or similar broadband modem that provides access to internet 104, which can be through one or more nodes, including nodes of an ISP. Moreover, mobile device 108 can be a UE, modem (or other tethered device), a portion thereof, and/or substantially any device that wirelessly communicates with femto node 102. Also, for example, LAN device 112 can be a computer or other device that can communicate with a router 110 in a LAN or other network.

For example, coupling the femto node 102 directly to the modem 106, as opposed to a router that shares modem access among multiple nodes in a LAN, allows the femto node 102 to manage communication flow to the modem 106. In an example, femto node 102 can prioritize communications received from mobile device 108 over those received from router 110 for providing to the modem 106, in some examples. Thus, mobile device 108 can communicate data having a specified QoS to femto node 102, and femto node 102 can provide the QoS for the data at least in part by prioritizing the data or the related connection over other data received from router 110 (e.g., which can originate at one or more devices, such as LAN device 112), dropping packets received from the femto node 102 for one or more LAN devices to improve latency and/or throughput for the mobile device 108, and/or the like. For example, the mobile device 108 can communicate VoIP packets to femto node 102, and femto node 102 can provide a requisite QoS for the VoIP packets by prioritizing the packets over other packets received from router 110 or other LAN devices.

To enable this configuration, in one example, femto node 102 can have a wireless interface to communicate with mobile devices, which can include a femtocell modem, and an associated network switch with at least two communication ports. Femto node 102 can communicate with modem 106 over one communication port and router 110 over another. For example, a femtocell modem can be a modem that includes one or more radio interfaces to which devices can connect to receive access to a mobile network, such as an LTE, UMTS, or similar interface. Thus, femto node 102 can deliver packets received over the communication port of the network switch connected with modem 106 to the femtocell modem, which can determine whether to communicate the packets to one or more mobile devices, or to forward the packets to a router or other network devices over another communication port of the network switch. Similarly, the femto node 102 can deliver packets received from the mobile devices over the femtocell modem, or packets received from the router 110 over a communication port of the network switch, to the communication port of the network switch connected to the modem 106. In one example, the femtocell modem can queue packets received over the communication port of the network switch connected to router 110 when prioritizing packets received from one or more mobile devices 108 over the femtocell modem to provide a QoS.

In addition, the communication ports in the switch can be associated with virtual local area network (VLAN) ports for allowing direct routing of packets specifying a given VLAN port. For example, packets received from the modem 106 over the associated VLAN port can be provided to the femtocell modem for forwarding to mobile device 108 and/or to the other communication port to which router 110 is connected, and/or vice versa. In addition, for example, the femto node 102 can provide local IP access (LIPA) to facilitate communications among mobile device 108 and LAN devices, such as LAN device 112. In one example, femto node 102 can include additional communication port(s) to which LAN devices can connect (e.g., via router 110 or otherwise) for LIPA, and/or an associated VLAN port. In this example, the femtocell modem can also receive packets sent through the LIPA communication port and can accordingly forward the packets to one or more mobile device(s) 108. Similarly, the femtocell modem can route LIPA packets from one or more mobile device(s) 108 over the LIPA communication port.

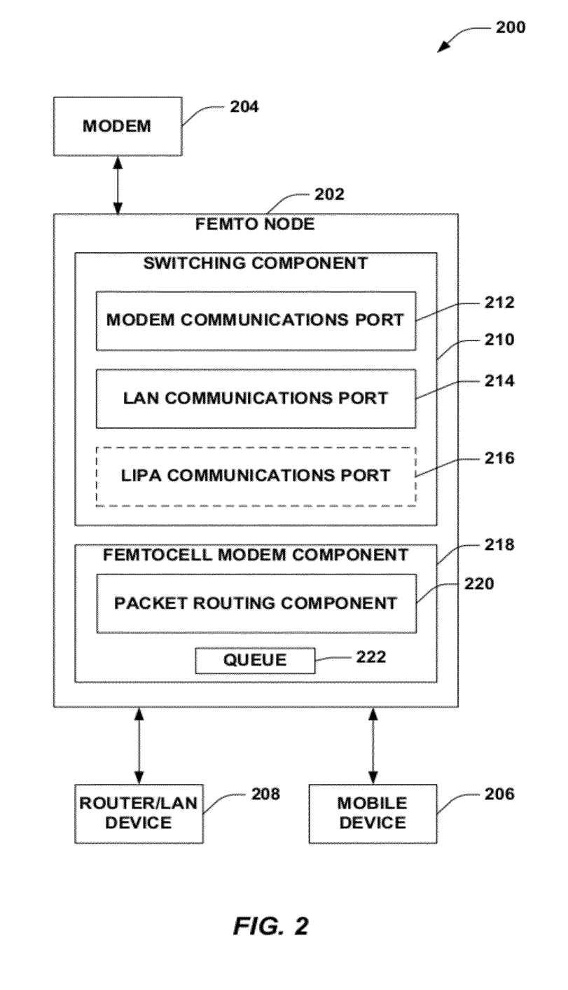

Turning now to FIG. 2, an example wireless communication system 200 that facilitates providing QoS for femto node communications is illustrated. System 200 can include a femto node 202 that communicates with a modem 204 to provide access to a broadband connection, as described. Femto node 202 also communicates with a mobile device 206 and/or a router/LAN device 208 to provide broadband access thereto. For example, femto node 202 can be substantially any kind of low power base station, as described, that provides mobile devices, etc. with access to a mobile network, modem 204 can be a DSL, cable, T1, or similar broadband modem, mobile device 206 can be a UE, modem, etc., router/LAN device 208 can be a router and/or LAN device (e.g., connected to a router or otherwise) including a server or other computer, a printer, a home media device (such as a digital video recorder), another network component, and/or substantially any device that can communicate over a LAN, as described previously.

Femto node 202 can comprise a switching component 210 for routing packets over one or more associated communication ports, such as a modem communications port 212, a LAN communications port 214, and/or an optional LIPA communications port 216. Femto node 202 can further comprise a femtocell modem component 218 for wirelessly communicating with one or more devices and directing packets to/from the switching component 210. In addition, femtocell modem component 218 can include a packet routing component 220 for routing received packets or packets for transmission over one or more VLAN ports.

According to an example, femto node 202 can be coupled to modem 204 by modem communications port 212, and thus femto node 202 can communicate over a broadband connection using modem 204 through modem communications port 212. For example, the modem communications port 212 can be a wide area network (WAN) Ethernet port similar to a WAN Ethernet port typically included in a router, a wireless LAN (WLAN) port that connects to modem 204 over a WLAN connection, an external device that connects to femto node 202 (e.g., via a universal serial bus (USB) or other port), such as a cellular modem or other communication device, and/or the like. Moreover, in an example, modem communications port 212 can be or can correspond to an associated VLAN port established between switching component 210 and femtocell modem component 218, such that communications received at switching component 210 intended for the VLAN port (e.g., identifying the VLAN port) from the modem communications port 212 can be forwarded over the modem communications port 212.

Similarly, femto node 202 can be coupled to router/LAN device 208 using LAN communications port 214. In this regard, for example, the LAN communications port 214 can be a LAN Ethernet or similar port (e.g., or a WLAN or other wireless port, etc.) that couples to the router/LAN device 208 (e.g., in a WAN Ethernet port on a router). Router/LAN device 208 can communicate packets over the LAN communications port 214 intended for communications over the broadband connection via modem 204. In this example, LAN communications port 214 can be or can correspond to a VLAN port established between switching component 210 and femtocell modem component 218, such that communications received over the LAN communications port 214 can be forwarded to femtocell modem component 218 over the associated VLAN port.

Switching component 210 can deliver communications received from modem 204 over modem communications port 212 to femtocell modem component 218 for determining whether the communications relate to one or more mobile devices or a LAN device (e.g., using a stateful packet filter). For example, this can include providing the communications over the VLAN port to femtocell modem component 218 related to the modem communications port 212. If the packets are intended for one or more mobile devices, packet routing component 220 can forward the communications to the appropriate mobile device 206. For example, an intended device can be indicated as one or more addresses in a header of the packet, and packet routing component 220 can determine whether the addresses correspond to the mobile device 206 or one or more other mobile devices. If the communications do not relate to the one or more mobile devices (e.g., the packets relate to a router and/or associated LAN devices), packet routing component 220 can forward the communications back to switching component 210 for communicating over LAN communications port 214. For example, packet routing component 222 can add an indication of the VLAN port related to LAN communications port 214, and switching component 210 can forward the communications over the LAN communications port 214 based on the specified VLAN port. In one example, as described below, the router/LAN device 208 can be assigned the same IP address as femto node 202 by the femto node 202; thus, packet routing component 220 can forward communications specifying this IP address to router/LAN device 208.

In another example, switching component 210 can deliver communications received from router/LAN device 208 over LAN communications port 214 to femtocell modem component 218 to allow packet routing component 220 to determine an order for transmitting communications over modem communications port 212. For example, upon receiving communications over the LAN communications port 214, switching component 210 can forward the communications to femtocell modem component 218 over the associated VLAN port. Packet routing component 220, in one example, can initially queue packets received over the VLAN port related to LAN communications port 214 in queue 222. In another example, the packet routing component 220 can queue packets in queue 222 further based on one or more determinations, such as whether there are active connections with one or more mobile devices 206, whether there are connections of a certain type with the one or more mobile devices 206 (e.g., VoIP connections), a QoS associated with one or more connections to one or more mobile devices, a connection state related to one or more mobile devices, an available uplink bandwidth with modem 204, and/or the like. Queuing packets based on such information can allow the packet routing component 220 to provide a QoS for connections form the mobile device(s) 206.

In either case, packet routing component 220 can provide packets from mobile devices 206 to switching component 210 for communication over modem communications port 212 (e.g., via the VLAN port related to modem communications port 212) before packets that are in the queue 222 or otherwise received from LAN communications port 214. In a specific example, where packets received from mobile device 206 are VoIP packets, packet routing component 220 can queue incoming packets from router/LAN device 208 in queue 222 until outstanding VoIP packets are forwarded to modem 204, and then can communicate the LAN packets from queue 222 to modem 204. Thus, packet routing component 220 communicates the VoIP packets to switching component 210 before other packets from router/LAN device 208 to help provide an optimal QoS for the VoIP packets. In another example, packet routing component 220 can drop packets intended for router/LAN device 208 (e.g., based on determining that an identifier of the packets corresponds to the router/LAN device 208). This can reduce queuing at the ISP accessed via the modem communications port 212, which can improve latency and throughput for packets received for the mobile devices 206, such as the VoIP packets.

Moreover, in this regard, femtocell modem component 218 can also be charged with assigning local network addresses to router/LAN device 208, mobile device 206, etc., and can thus implement a dynamic host configuration protocol (DHCP) server, for example. Thus, packet routing component 220 can determine whether to deliver packets to mobile devices 206 or router/LAN device via LAN communications port 214 based on the assigned addresses. In one example, femto node 202 can receive an IP address assignment from modem 204 for communicating therewith, and femtocell modem component 218 can assign the same IP address to router/LAN device 208 to facilitate routing of packets from router/LAN device 208 to femtocell modem component 218 via switching component 210 and/or vice versa without requiring modification of functionality at router/LAN device 208.

In an example, to support VLAN port routing, as described above, switching component 210 and/or packet routing component 220 can embed a VLAN header in communications so that the receiving component can route packets to/from the appropriate communications port. In another example, packet routing component 220 can utilize different media access control (MAC) addresses for each VLAN port, and the related MAC addresses can be specified for sending/receiving communications over each VLAN port.

Moreover, in an example, where packet routing component 220 determines that communications from mobile device 206 should be prioritized over communications received over LAN communications port 214 or otherwise stored in queue 222, packet routing component 220 can measure available bandwidth for uplink transmission (e.g., from static information or dynamic measurement at modem 204), reduce a rate of transmission of uplink data to uplink bandwidth available at modem 204, and prioritize the data with an associated QoS over that received from LAN communications port 214. In this regard, it is to be appreciated that packet routing component 220 can prioritize the data with an associated QoS over that received from that received from LAN communications port 214 or stored in queue 222 by not transmitting the data received from LAN communications port 214 or stored in queue 222, lowering a transmission rate thereof, and/or the like.

In yet another example, femto node 202 can provide LIPA functionality to mobile device 206 and router/LAN device 208 (e.g., and/or devices coupled thereto). In one example, switching component 210 can include a LIPA communications port 216 that is coupled to the router/LAN device 208 as well (e.g., via a wired LAN port, WLAN antenna port, etc.). In addition, switching component 210 can include another VLAN port associated with the LIPA communications port 216. Thus, femto node 202 can receive an IP address from router/LAN device 208 for communicating in the network thereof. For example, this can include obtaining the IP address via Ethernet, WiFi, and/or other connectivity supported by router/LAN device 208. In this regard, the LIPA communications port 216 can be or can correspond to a LIPA VLAN port associated with femtocell modem component 218, such that packets received over LIPA communications port 216 from router/LAN device 208 can similarly be routed to femtocell modem component 218 over the VLAN port. In this example, packet routing component 220 can route the packets to a specified mobile device 206. In addition, for LIPA packets received from mobile device 206, packet routing component 220 can add a VLAN header related to the VLAN port corresponding to LIPA communications port 216 to the LIPA packets and forward the LIPA packets to switching component 210. Based at least in part on the VLAN port identified in the header, switching component 210 can deliver the packets over LIPA communications port 216 to router/LAN device 208.

Though shown as implemented within femto node 202, it is to be appreciated that the switching component 210 can be a separate component so long as switching component 210 provides at least a modem communications port 212, LAN communications port 214, and associated VLAN ports to femtocell modem component 218. Moreover, the terms packets and communications are used interchangeably herein to describe data received from the mobile device 206, router/LAN device 208, and modem 204.

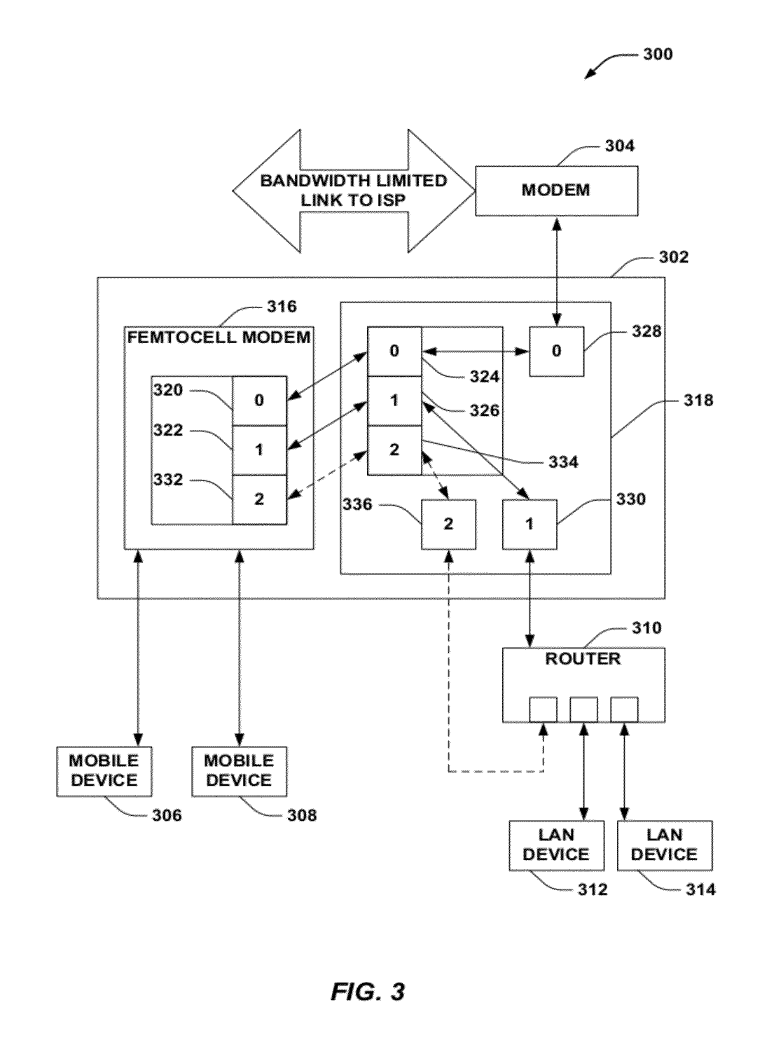

FIG. 3 shows an example system 300 for prioritizing mobile device communications over LAN communications. System 300 includes a femto node 302 that communicates with a modem 304 to receive bandwidth limited access to an ISP or other network connection. System 300 also includes one or more mobile devices 306 and 308 communicating with femto node 302 and a router 310 that can also communicate with femto node 302 to receive access to one or more nodes via the bandwidth limited link to the ISP. In addition, router 310 can provide similar access to one or more LAN devices 312 and/or 314. Moreover, router 310 can include switching functionality to allow communications between LAN devices 312 and/or 314.

As depicted, femto node 302 can include a femtocell modem 316 that provides mobile network access to the one or more mobile devices 306 and/or 308 via the bandwidth limited link to the ISP, and a switch 318 that routes packets among the modem 304, femtocell modem 316, and router 310. For example, femtocell modem 316 can include VLAN port 0 320 and VLAN port 1 322, that are respectively associated with a VLAN port 0 324 and VLAN port 1 326 of the switch 318. The switch 318 has a physical port 0 328 associated with VLAN port 324 and coupled to modem 304, and a physical port 1 330 associated with VLAN port 1 326 and coupled to router 310. For example, the physical ports can correspond to Ethernet ports, WLAN antenna ports, or other ports that can couple to the modem 304 and router 310 (e.g., or another LAN component or device). Moreover, the VLAN ports 320, 322, 324, and 326 can be physical ports as well, interconnected by wired or wireless media, that support inter-switch link (ISL), IEEE 802.1Q standard, and/or the like.

In an example, femtocell modem 316 can provide a radio interface to communicate with mobile devices 306 and 308. For example, the femtocell modem 316 can implement one or more wireless radio technologies to provide similar access as a macro base station, such as 3GPP LTE, WiMAX, etc. Thus, femtocell modem 316 can receive communications from mobile devices 306 and 308, and can forward the communications over VLAN port 0 320, which can be received at the switch 318 over VLAN port 0 324, and the switch 318 can provide the communications to modem 304. Communications received from router 310 over physical port 330 are forwarded to VLAN port 1 322 of the femtocell modem 316 via VLAN port 1 326 on the switch 318. In this regard, the femtocell modem 316 can control transmission of communications from router 310 to provide a QoS for communications from one or more mobile devices 306 and/or 308. In one example, femtocell modem 316 can queue communications from router 310 while transmitting communications from mobile devices 306 and/or 308 to modem 304 via switch 318, as described.

In one example, femtocell modem 316 can determine when to provide QoS for communications from the mobile devices 306 and/or 308 based in part on one or more parameters, such as a type of communications received therefrom, a QoS specified for a corresponding connection, whether there are communications outstanding for the mobile devices 306 and/or 308 (e.g., whether communications are buffered), and/or the like. In one example, the femtocell modem 316 can measure uplink bandwidth available from modem 304 (e.g., through the various ports), which can be received statically or dynamically therefrom, and can determine whether to prioritize communications from mobile devices 306 and/or 308 based in part on the available uplink bandwidth. In an example, femtocell modem 316 can reduce a rate of transmission of uplink data to modem 304 based on the determined available uplink bandwidth, and can utilize the rate in determining whether a QoS is provided to the mobile devices 306 and/or 308 before considering whether to forward communications from router 310. Once femtocell modem 316 determines to transmit communications from router 310, femtocell modem 316 can similarly forward the communications over VLAN port 0 320 to switch 318, which receives the communications via VLAN port 0 324, and forwards to modem 304.

For communications received by modem 304 over physical port 0 328, switch 318 can forward the communications to femtocell modem 316 over VLAN port 0 324, which is received at VLAN port 0 320. Femtocell modem 316 can implement a stateful filter to determine whether the communications relate to one or more mobile devices 306 and/or 308, router 310, etc. Where the communications relate to one or more mobile devices 306 and/or 308, the communications are sent thereto over the radio interface of femtocell modem 316. Where the communications relate to router 310, femtocell modem 316 can forward the communications thereto over VLAN port 1 322, which are received at VLAN port 1 326, and forwarded to router 310 over physical port 330. In another example, to provide QoS for the mobile devices 306 and/or 308 or otherwise, femtocell modem 316 can drop communications received from modem 304 intended for the router 310, LAN devices 312, 314, and/or the like. This can reduce queuing at the ISP and/or cause congestion control to be implemented (e.g., TCP congestion control). For example, this can reduce packet flow from ISP for the router 310, LAN devices 312, 314, etc., and can thus improve downlink latency and throughput for mobile devices 306 and/or 308.

In one example, femtocell modem 316 can embed a VLAN header in communications for router 310 when forwarding to the switch 318, where the VLAN header can include a VLAN identifier of VLAN port 1 322 using ISL, 802.1Q, or other VLAN technologies. The switch 318 can accordingly receive the communications over VLAN port 1 326 and forward the communications over physical port 330—in one example, the switch 318 can remove the VLAN header and/or associated identifier before forwarding the communications over physical port 330. In another example, femtocell modem 316 can indicate different MAC addresses for different VLAN ports, and can thus indicate a MAC address for VLAN port 1 324 in the communications for forwarding to router 310. In any case, router 310 can then route the communications to one or more LAN devices 312 or 314, in one example. In one example, modem 304 can assign an IP address to femtocell modem 316, and femtocell modem 316 can assign the same address to router 310.

Moreover, the femto node 302 can include various ports to implement LIPA. For example, femtocell modem 316 can include a VLAN port 2 332 associated with VLAN port 2 334 on the switch 318, which can connect with physical port 336. As shown, physical port 336 can be coupled to a port on router 310 to facilitate LIPA between one or more LAN devices 312 and/or 314 and the mobile devices 306 and/or 308. In this example, communications received over physical port 336 from router 310 are forwarded to femtocell modem 316 over VLAN port 2 334, which provides the communications to VLAN port 2 332. The femtocell modem 316 can determine the communications are for LIPA based at least in part on receiving over VLAN port 2 332. The femtocell modem 316 can thus determine an associated mobile device 306 and/or 308 to receive the LIPA communications (e.g., based on an indicated destination address in an IP header of the communications), and can forward the communications thereto.

In another example, for communications received from mobile device 306 and/or 308, femtocell modem 316 can determine whether the communications correspond to LIPA. For example, this can be based on an indicator in the communications, an indicated destination address of the communications, and/or the like. In any case, femtocell modem 316 can forward LIPA communications over VLAN port 2 332, which can include adding a VLAN address for VLAN port 2 to the communications, as described. VLAN port 2 334 can receive the communications and can forward to router 310 over physical port 2 336. The router 310 can route the LIPA communications based on further information indicated in the communications (e.g., a local IP address of the appropriate LAN device 312 and/or 314, etc.).

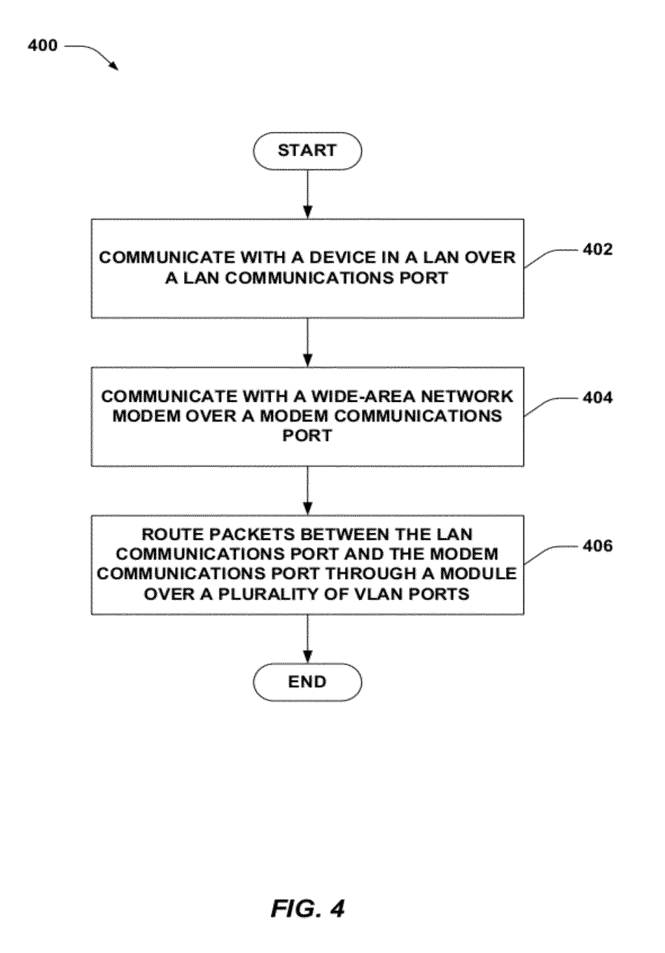

FIGS. 4-7 illustrate example methodologies relating to routing packets at a femto node. While, for purposes of simplicity of explanation, the methodologies are shown and described as a series of acts, it is to be understood and appreciated that the methodologies are not limited by the order of acts, as some acts may, in accordance with one or more embodiments, occur concurrently with other acts and/or in different orders from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

FIG. 4 depicts an example methodology 400 for routing packets between ports of a femto node. At 402, a device in a LAN can be communicated with over a LAN communications port. For example, this can include coupling to a port on a switch (e.g., a physical port, a wireless antenna port, and/or the like) or other LAN component to communicate with the device over a wired or wireless connection.

At 404, a wide-area network modem can be communicated with over a modem communications port. Similarly, this can include coupling to a port on the modem (e.g., a physical port, a wireless antenna port for wireless connection, etc.) to utilize a broadband link to an ISP or other network components.

At 406, packets can be routed between the LAN communications port and the modem communications port through a module over a plurality of VLAN ports. For example, the module can be a femtocell modem or other component that can further receive communications from other devices over another interface (e.g., from mobile devices over a radio interface) and can determine routing of packets from the other devices as well. Thus, in one example, packets received over the LAN communications port can be routed to the femtocell modem over the corresponding VLAN port to allow the femtocell modem to prioritize the packets with those received from mobile devices. The femtocell modem can route the prioritized packets to the modem communications port over the associated VLAN port. Packets received over the modem communications port can be routed to the femtocell modem over the corresponding VLAN port for determining whether the packets relate to mobile devices or LAN devices. The femtocell modem can then forward packets to the LAN devices over the associated VLAN port assigned to the LAN communications port.

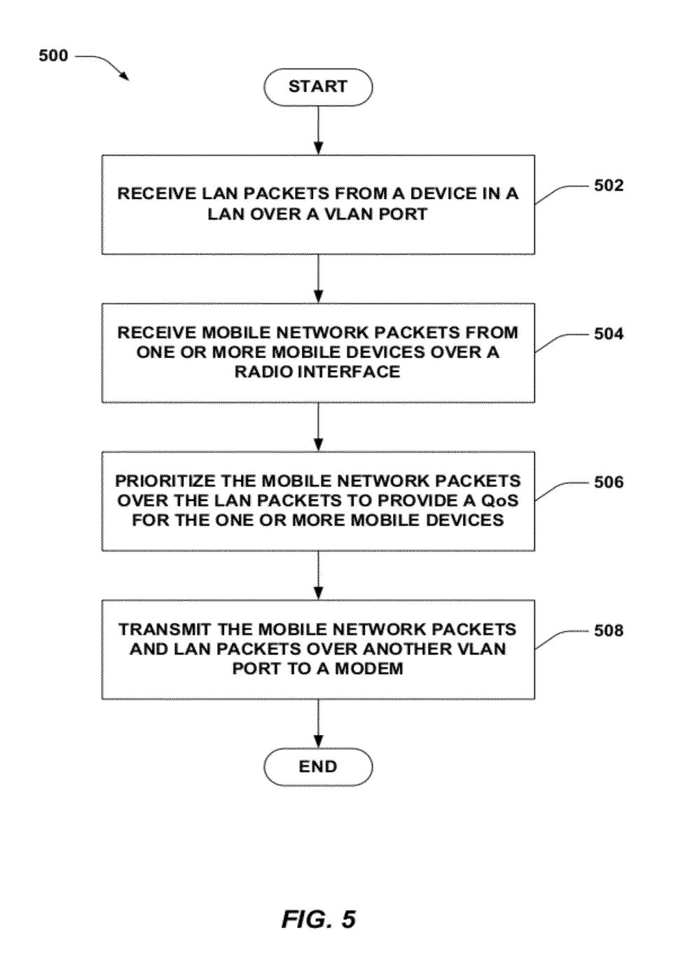

FIG. 5 illustrates an example methodology 500 for prioritizing packets from LAN devices and mobile devices. At 502, LAN packets can be received from a device in a LAN over a VLAN port. For example, a LAN communications port coupled to the LAN device or a related router can be associated with a VLAN port such that the packets communicated thereover are received from the VLAN port. In one example, the packets can be received at a femtocell modem (e.g., from a router or otherwise), as described.

At 504, mobile network packets can be received from one or more mobile devices over a radio interface. The radio interface can correspond to substantially any radio interface provided by base stations in a mobile network, such as 3GPP LTE, WiMAX, etc. The one or more mobile devices can communicate over the radio interface to receive access to a corresponding mobile network, as described.

At 506, the mobile network packets can be prioritized over the LAN packets to provide a QoS for the one or more mobile devices. In one example, the LAN packets can be queued for a period of time to ensure the one or more mobile devices achieve a throughput related to a QoS specified for a related connection. Since a related broadband connection can provide varying throughput, this allows for throttling the LAN packets based on throughput of the mobile network packets to provide the QoS for the one or more mobile devices.

At 508, the mobile network packets and LAN packets can be transmitted over another VLAN port to a modem. As described, the VLAN port can be associated with a physical port, a wireless antenna port, and/or the like that is coupled to the modem. The modem can route the packets to one or more components of an ISP, for example.

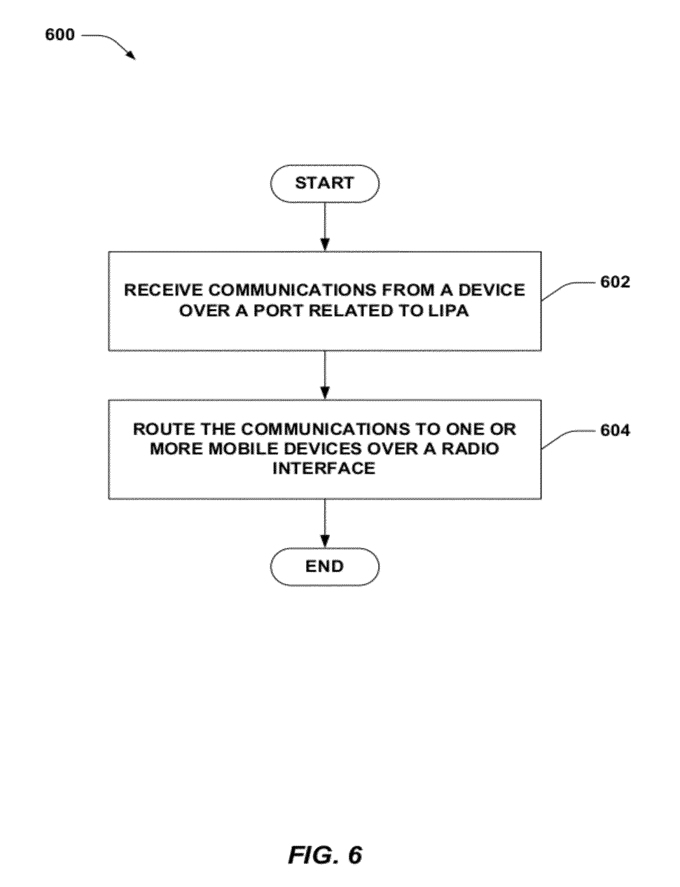

FIG. 6 illustrates an example methodology 600 for providing routing for LIPA packets. At 602, communications can be received from a device over a port related to LIPA. For example, the port can be a VLAN port associated with a physical port (e.g., a wired port, a wireless antenna port, etc.) connected to a LAN device. For example, the port can be coupled to a router that communicates with the LAN device. At 604, the communications can be routed to one or more mobile devices over a radio interface. For example, it can be determined that the communications relate to LIPA based on receiving the communications over the port related to LIPA, and thus a destination address of a mobile device can be determined. The routing at 604 can be based in part on the destination address.

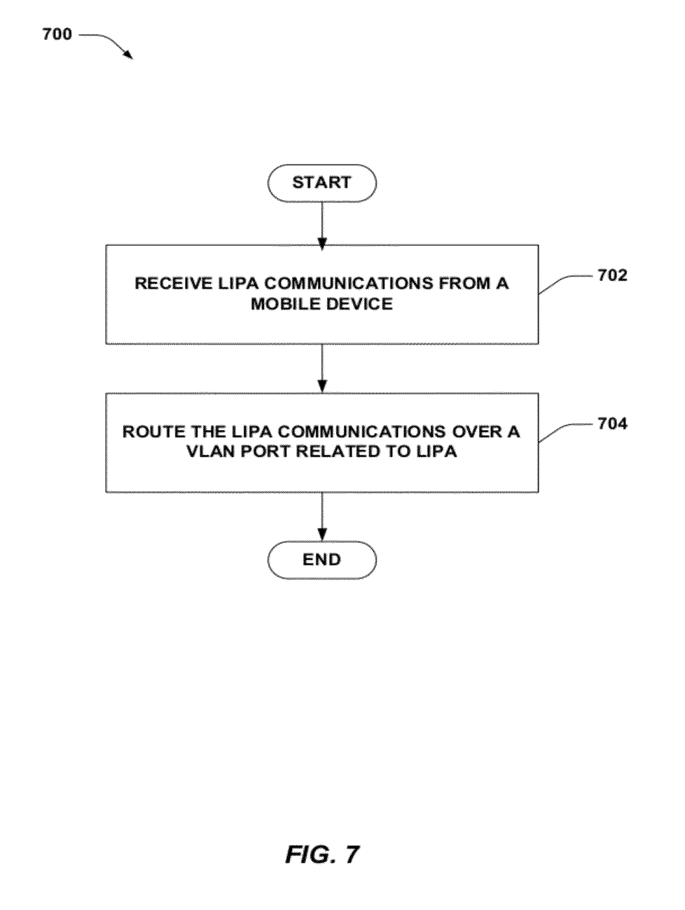

FIG. 7 shows an example methodology 700 for providing routing for LIPA packets. At 702, LIPA communications can be received from a mobile device. For example, the LIPA communications can be received over a radio interface and can be determined to be LIPA communications based on an indicator in the communications, a destination address specified in the communications, and/or the like. At 704, the LIPA communications can be routed over a VLAN port related to LIPA. For example, after the communications are determined to be LIPA communications, the communications can be forwarded to a VLAN port associated with a physical port for LIPA. The physical port can be coupled to a LAN device or a related router, as described, which can receive the communications forwarded over the port.

It will be appreciated that, in accordance with one or more aspects described herein, inferences can be made regarding determining routing of communications over various VLAN ports, prioritizing mobile network packets, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

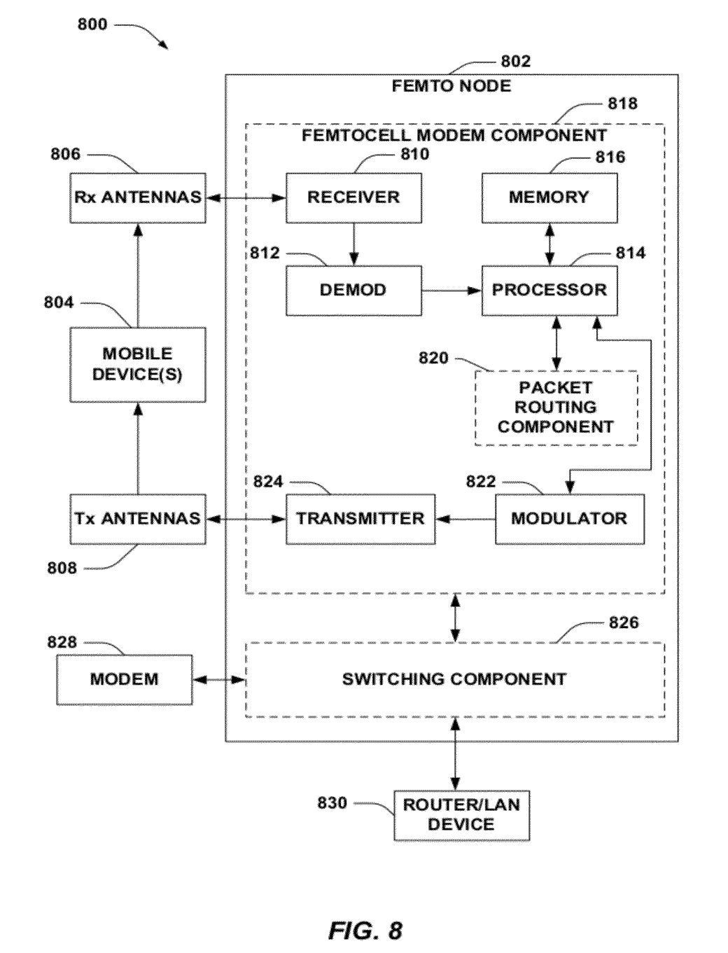

FIG. 8 is an illustration of a system 800 that facilitates routing packets to a modem. System 800 includes a femto node 802 having a receiver 810 that receives signal(s) from one or more mobile devices through a plurality of receive antennas 806 (e.g., which can be of multiple network technologies, as described), and a transmitter 824 that transmits to the one or more mobile devices through a plurality of transmit antennas 808 (e.g., which can be of multiple network technologies, as described). Receiver 810 can receive information from one or more receive antennas 806 and is operatively associated with a demodulator 812 that demodulates received information. Though depicted as separate antennas, it is to be appreciated that at least one of receive antennas 806 and a corresponding one of transmit antennas 808 can be combined as the same antenna. Demodulated symbols are analyzed by a processor 814, which is coupled to a memory 816 that stores information related to performing one or more aspects described herein. Receiver 810, demodulator 812, processor 814, and memory 816 can be included within a femtocell modem component 818 portion of the femto node 802.

Processor 814, for example, can be a processor dedicated to analyzing information received by receiver 810 and/or generating information for transmission by a transmitter 824, a processor that controls one or more components or modules of femto node 802, and/or a processor that analyzes information received by receiver 810, generates information for transmission by transmitter 824, and controls one or more components or modules of femto node 802. In addition, processor 814 can perform one or more functions described herein and/or can communicate with components or modules for such a purpose. Moreover, for example, processor 814 can be coupled to a modulator 822 for modulating signals to be transmitted by transmitter 824. Transmitter 824 can transmit signals to mobile devices 804 over Tx antennas 808.

Memory 816, as described, is operatively coupled to processor 814 and can store data to be transmitted, received data, information related to available channels, data associated with analyzed signal and/or interference strength, information related to an assigned channel, power, rate, or the like, and any other suitable information for estimating a channel and communicating via the channel. Memory 816 can additionally store protocols and/or algorithms associated with detecting handover events and/or assigning protected resources to one or more devices.

It will be appreciated that the data store (e.g., memory 816) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 816 of the subject systems and methods is intended to comprise, without being limited to, these and any other suitable types of memory.

Processor 814 is further optionally coupled to a packet routing component 820, which can be similar to packet routing component 220. Femto node 802 also includes a switching component 826 that can be similar to switching component 210 for routing packets between femtocell modem component 818, a modem 828, and a router/LAN device 830, as described herein. Furthermore, although depicted as being separate from the processor 814, it is to be appreciated that the packet routing component 820, demodulator 812, and/or modulator 822 can be part of the processor 814 or multiple processors (not shown), and/or stored as instructions in memory 816 for execution by processor 814. Switching component 826 can be substantially any network switch operable to route packets over VLAN ports, as described.

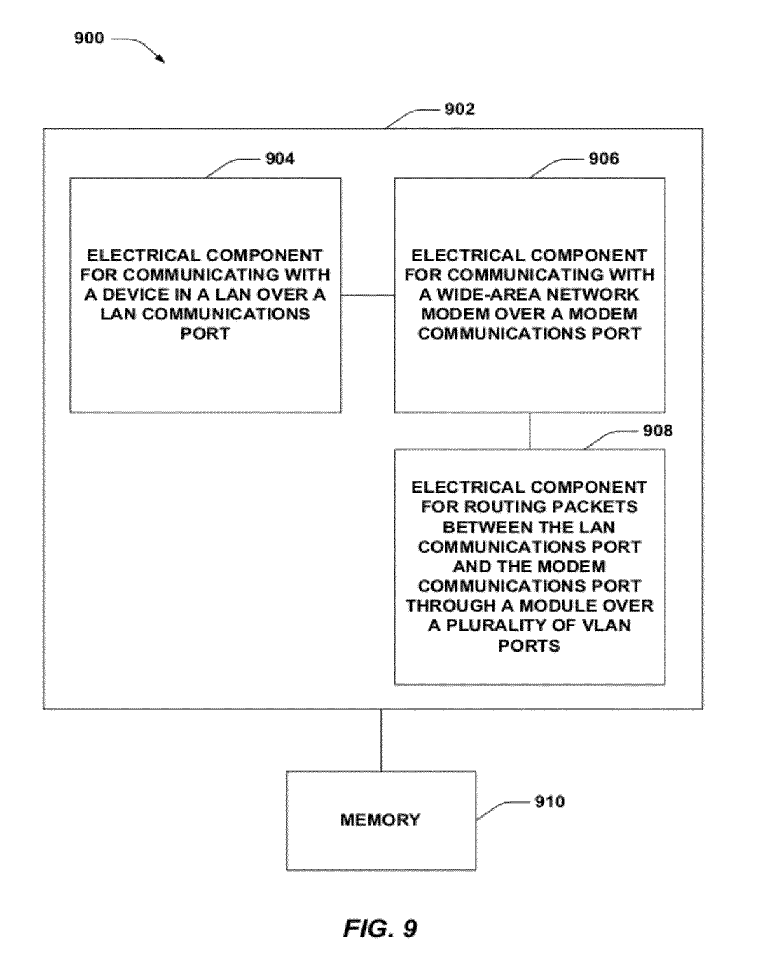

FIG. 9 illustrates a system 900 for routing packets from mobile devices and LAN devices. For example, system 900 can reside at least partially within a femto node or other low power base station. It is to be appreciated that system 900 is represented as including functional blocks, which can be functional blocks that represent functions implemented by a processor, software, or combination thereof (e.g., firmware). System 900 includes a logical grouping 902 of electrical components that can act in conjunction. For instance, logical grouping 902 can include an electrical component for communicating with a device in a LAN over a LAN communications port 904. As described, the LAN communications port can have an associated VLAN port over which the communications are received.

Further, logical grouping 902 can comprise an electrical component for communicating with a wide-area network modem over a modem communications port 906. This can include communicating over an associated VLAN port, as described, that results in routing packets to/from the modem communications port. Logical grouping 902 also comprises an electrical component for routing packets between the LAN communications port and the modem communications port through a module over a plurality of VLAN ports 908. As described, the packets can be received at the module, which can include a femtocell modem, which can prioritize packets from the LAN device with packets from mobile devices for routing to the modem, and/or can identify whether packets received from the modem correspond to the LAN device. For example, electrical component 904 can include a switching component 210 or associated LAN communications port 214, as described above. In addition, for example, electrical component 906, in an aspect, can include a switching component 210 or associated modem communications port 212, as described above, and/or electrical component 908 can include a switching component 210 that communicates with a femtocell modem component 218, which can be the module.

Additionally, system 900 can include a memory 910 that retains instructions for executing functions associated with the electrical components 904, 906, and 908. While shown as being external to memory 910, it is to be understood that one or more of the electrical components 904, 906, and 908 can exist within memory 910. In one example, electrical components 904, 906, and 908 can comprise at least one processor, or each electrical component 904, 906, and 908 can be a corresponding module of at least one processor. Moreover, in an additional or alternative example, electrical components 904, 906, and 908 can be a computer program product comprising a computer readable medium, where each electrical component 904, 906, and 908 can be corresponding code.

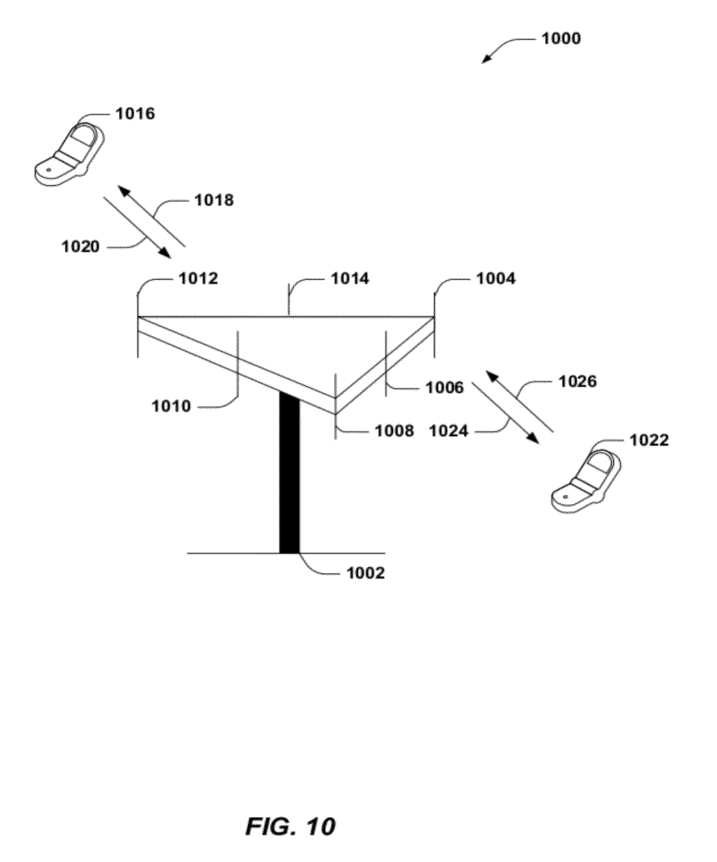

FIG. 10 illustrates a wireless communication system 1000 in accordance with various embodiments presented herein. System 1000 comprises a base station 1002 that can include multiple antenna groups. For example, one antenna group can include antennas 1004 and 1006, another group can comprise antennas 1008 and 1010, and an additional group can include antennas 1012 and 1014. Two antennas are illustrated for each antenna group; however, more or fewer antennas can be utilized for each group. Base station 1002 can additionally include a transmitter chain and a receiver chain, each of which can in turn comprise a plurality of components or modules associated with signal transmission and reception (e.g., processors, modulators, multiplexers, demodulators, demultiplexers, antennas, etc.), as is appreciated.

Base station 1002 can communicate with one or more mobile devices such as mobile device 1016 and mobile device 1022; however, it is to be appreciated that base station 1002 can communicate with substantially any number of mobile devices similar to mobile devices 1016 and 1022. Mobile devices 1016 and 1022 can be, for example, cellular phones, smart phones, laptops, handheld communication devices, handheld computing devices, satellite radios, global positioning systems, PDAs, and/or any other suitable device for communicating over wireless communication system 1000. As depicted, mobile device 1016 is in communication with antennas 1012 and 1014, where antennas 1012 and 1014 transmit information to mobile device 1016 over a forward link 1018 and receive information from mobile device 1016 over a reverse link 1020. Moreover, mobile device 1022 is in communication with antennas 1004 and 1006, where antennas 1004 and 1006 transmit information to mobile device 1022 over a forward link 1024 and receive information from mobile device 1022 over a reverse link 1026. In a frequency division duplex (FDD) system, forward link 1018 can utilize a different frequency band than that used by reverse link 1020, and forward link 1024 can employ a different frequency band than that employed by reverse link 1026, for example. Further, in a time division duplex (TDD) system, forward link 1018 and reverse link 1020 can utilize a common frequency band and forward link 1024 and reverse link 1026 can utilize a common frequency band.

Each group of antennas and/or the area in which they are designated to communicate can be referred to as a sector of base station 1002. For example, antenna groups can be designed to communicate to mobile devices in a sector of the areas covered by base station 1002. In communication over forward links 1018 and 1024, the transmitting antennas of base station 1002 can utilize beamforming to improve signal-to-noise ratio of forward links 1018 and 1024 for mobile devices 1016 and 1022. Also, while base station 1002 utilizes beamforming to transmit to mobile devices 1016 and 1022 scattered randomly through an associated coverage, mobile devices in neighboring cells can be subject to less interference as compared to a base station transmitting through a single antenna to all its mobile devices. Moreover, mobile devices 1016 and 1022 can communicate directly with one another using a peer-to-peer or ad hoc technology as depicted.

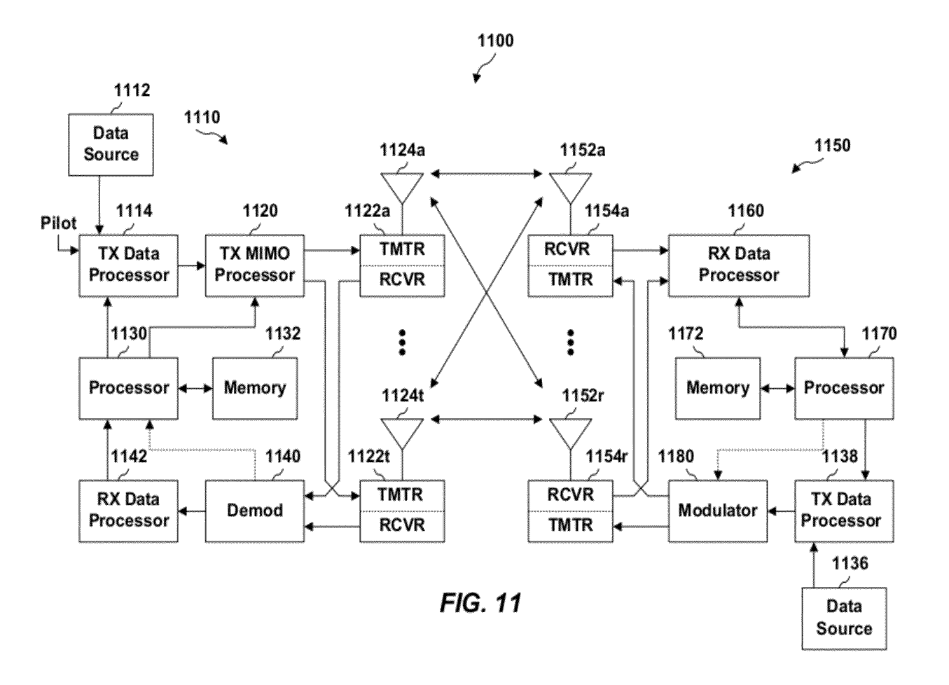

FIG. 11 shows an example wireless communication system 1100. The wireless communication system 1100 depicts one base station 1110 and one mobile device 1150 for sake of brevity. However, it is to be appreciated that system 1100 can include more than one base station and/or more than one mobile device, wherein additional base stations and/or mobile devices can be substantially similar or different from example base station 1110 and mobile device 1150 described below. Moreover, base station 1110 can be a low power base station, in one example, such as one or more femto nodes previously described. In addition, it is to be appreciated that base station 1110 and/or mobile device 1150 can employ the systems (FIGS. 1-3 and 8-10) and/or methods (FIGS. 4-7) described herein to facilitate wireless communication there between. For example, components or functions of the systems and/or methods described herein can be part of a memory 1132 and/or 1172 or processors 1130 and/or 1170 described below, and/or can be executed by processors 1130 and/or 1170 to perform the disclosed functions.

At base station 1110, traffic data for a number of data streams is provided from a data source 1112 to a transmit (TX) data processor 1114. According to an example, each data stream can be transmitted over a respective antenna. TX data processor 1114 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1150 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1130.

The modulation symbols for the data streams can be provided to a TX MIMO processor 1120, which can further process the modulation symbols (e.g., for OFDM). TX MIMO processor 1120 then provides N_{T} modulation symbol streams to N_{T} transmitters (TMTR) 1122a through 1122t. In various embodiments, TX MIMO processor 1120 applies beamforming weights to the symbols of the data streams and to the antenna from which the symbol is being transmitted.

Each transmitter 1122 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1122a through 1122t are transmitted from N_{T} antennas 1124a through 1124t, respectively.

At mobile device 1150, the transmitted modulated signals are received by N_{R} antennas 1152a through 1152r and the received signal from each antenna 1152 is provided to a respective receiver (RCVR) 1154a through 1154r. Each receiver 1154 conditions (e.g., filters, amplifies, and downconverts) a respective signal, digitizes the conditioned signal to provide samples, and further processes the samples to provide a corresponding “received” symbol stream.

An RX data processor 1160 can receive and process the N_{R} received symbol streams from N_{R} receivers 1154 based on a particular receiver processing technique to provide N_{T} “detected” symbol streams. RX data processor 1160 can demodulate, deinterleave, and decode each detected symbol stream to recover the traffic data for the data stream. The processing by RX data processor 1160 is complementary to that performed by TX MIMO processor 1120 and TX data processor 1114 at base station 1110.

The reverse link message can comprise various types of information regarding the communication link and/or the received data stream. The reverse link message can be processed by a TX data processor 1138, which also receives traffic data for a number of data streams from a data source 1136, modulated by a modulator 1180, conditioned by transmitters 1154a through 1154r, and transmitted back to base station 1110.

At base station 1110, the modulated signals from mobile device 1150 are received by antennas 1124, conditioned by receivers 1122, demodulated by a demodulator 1140, and processed by a RX data processor 1142 to extract the reverse link message transmitted by mobile device 1150. Further, processor 1130 can process the extracted message to determine which precoding matrix to use for determining the beamforming weights.

Processors 1130 and 1170 can direct (e.g., control, coordinate, manage, etc.) operation at base station 1110 and mobile device 1150, respectively. Respective processors 1130 and 1170 can be associated with memory 1132 and 1172 that store program codes and data. For example, processor 1130 and/or 1170 can execute, and/or memory 1132 and/or 1172 can store instructions related to functions and/or components described herein, such as determining routing of packets based on receiving packets over one or more VLAN ports or a radio interface, based on a destination address indicated in the packets, and/or the like, as described.

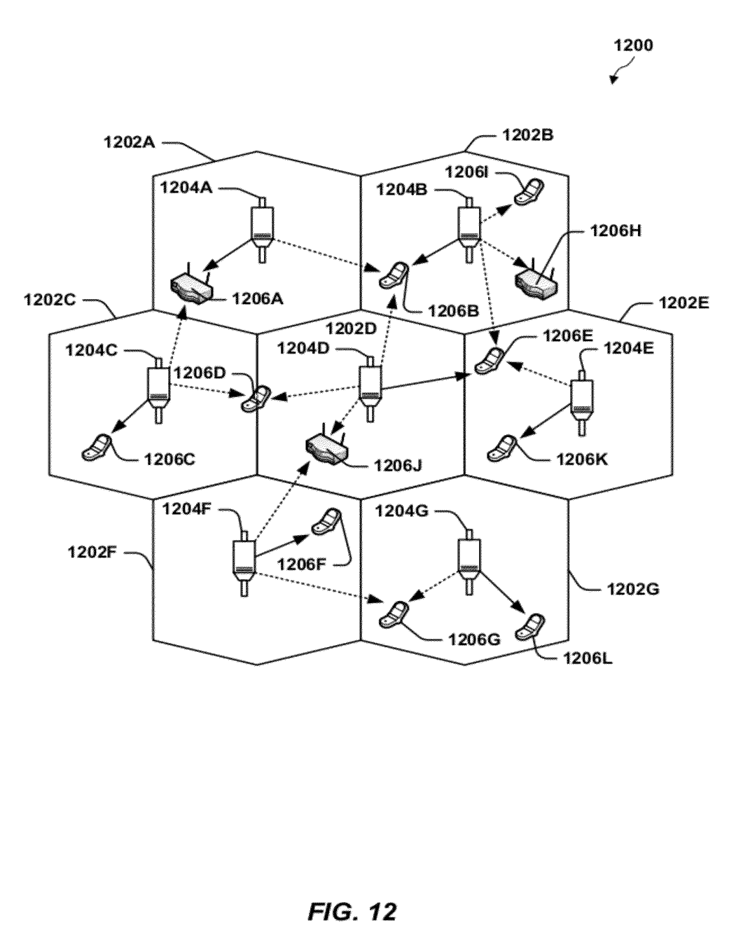

FIG. 12 illustrates a wireless communication system 1200, configured to support a number of users, in which the teachings herein may be implemented. The system 1200 provides communication for multiple cells 1202, such as, for example, macro cells 1202A-1202G, with each cell being serviced by a corresponding access node 1204 (e.g., access nodes 1204A-1204G). As shown in FIG. 12, access terminals 1206 (e.g., access terminals 1206A-1206L) can be dispersed at various locations throughout the system over time. Each access terminal 1206 can communicate with one or more access nodes 1204 on a forward link (FL) and/or a reverse link (RL) at a given moment, depending upon whether the access terminal 1206 is active and whether it is in soft handoff, for example. The wireless communication system 1200 can provide service over a large geographic region.

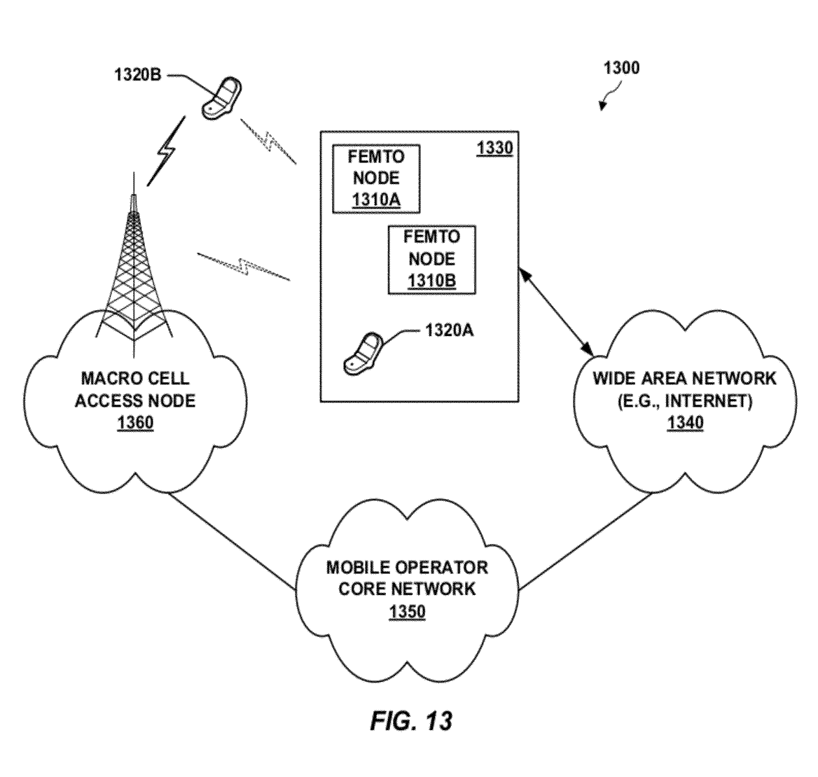

FIG. 13 illustrates an exemplary communication system 1300 where one or more femto nodes are deployed within a network environment. Specifically, the system 1300 includes multiple femto nodes 1310A and 1310B (e.g., femtocell nodes or H(e)NB) installed in a relatively small scale network environment (e.g., in one or more user residences 1330). Each femto node 1310 can be coupled to a wide area network 1340 (e.g., the Internet) and a mobile operator core network 1350 via a digital subscriber line (DSL) router, a cable modem, a wireless link, or other connectivity means (not shown). As will be discussed below, each femto node 1310 can be configured to serve associated access terminals 1320 (e.g., access terminal 1320A) and, optionally, alien access terminals 1320 (e.g., access terminal 1320B). In other words, access to femto nodes 1310 can be restricted such that a given access terminal 1320 can be served by a set of designated (e.g., home) femto node(s) 1310 but may not be served by any non-designated femto nodes 1310 (e.g., a neighbor's femto node).

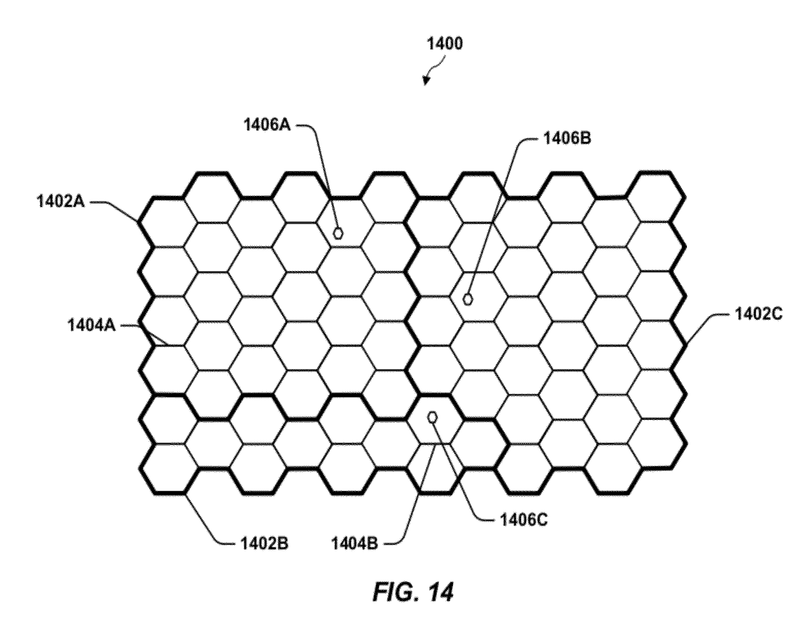

FIG. 14 illustrates an example of a coverage map 1400 where several tracking areas 1402 (or routing areas or location areas) are defined, each of which includes several macro coverage areas 1404. Here, areas of coverage associated with tracking areas 1402A, 1402B, and 1402C are delineated by the wide lines and the macro coverage areas 1404 are represented by the hexagons. The tracking areas 1402 also include femto coverage areas 1406. In this example, each of the femto coverage areas 1406 (e.g., femto coverage area 1406C) is depicted within a macro coverage area 1404 (e.g., macro coverage area 1404B). It should be appreciated, however, that a femto coverage area 1406 may not lie entirely within a macro coverage area 1404. In practice, a large number of femto coverage areas 1406 can be defined with a given tracking area 1402 or macro coverage area 1404. Also, one or more pico coverage areas (not shown) can be defined within a given tracking area 1402 or macro coverage area 1404.

Referring again to FIG. 13, the owner of a femto node 1310 can subscribe to mobile service, such as, for example, 3G mobile service, offered through the mobile operator core network 1350. In addition, an access terminal 1320 can be capable of operating both in macro environments and in smaller scale (e.g., residential) network environments. Thus, for example, depending on the current location of the access terminal 1320, the access terminal 1320 can be served by an access node 1360 or by any one of a set of femto nodes 1310 (e.g., the femto nodes 1310A and 1310B that reside within a corresponding user residence 1330). For example, when a subscriber is outside his home, he is served by a standard macro cell access node (e.g., node 1360) and when the subscriber is at home, he is served by a femto node (e.g., node 1310A). Here, it should be appreciated that a femto node 1310 can be backward compatible with existing access terminals 1320.

A femto node 1310 can be deployed on a single frequency or, in the alternative, on multiple frequencies. Depending on the particular configuration, the single frequency or one or more of the multiple frequencies can overlap with one or more frequencies used by a macro cell access node (e.g., node 1360). In some aspects, an access terminal 1320 can be configured to connect to a preferred femto node (e.g., the home femto node of the access terminal 1320) whenever such connectivity is possible. For example, whenever the access terminal 1320 is within the user's residence 1330, it can communicate with the home femto node 1310.

In some aspects, if the access terminal 1320 operates within the mobile operator core network 1350 but is not residing on its most preferred network (e.g., as defined in a preferred roaming list), the access terminal 1320 can continue to search for the most preferred network (e.g., femto node 1310) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the access terminal 1320 can limit the search for specific band and channel. For example, the search for the most preferred system can be repeated periodically. Upon discovery of a preferred femto node, such as femto node 1310, the access terminal 1320 selects the femto node 1310 for camping within its coverage area.

A femto node can be restricted in some aspects. For example, a given femto node can only provide certain services to certain access terminals. In deployments with so-called restricted (or closed) association, a given access terminal can only be served by the macro cell mobile network and a defined set of femto nodes (e.g., the femto nodes 1310 that reside within the corresponding user residence 1330). In some implementations, a femto node can be restricted to not provide, for at least one access terminal, at least one of: signaling, data access, registration, paging, or service.

In some aspects, a restricted femto node (which can also be referred to as a Closed Subscriber Group H(e)NB) is one that provides service to a restricted provisioned set of access terminals. This set can be temporarily or permanently extended as necessary. In some aspects, a Closed Subscriber Group (CSG) can be defined as the set of access nodes (e.g., femto nodes) that share a common access control list of access terminals. A channel on which all femto nodes (or all restricted femto nodes) in a region operate can be referred to as a femto channel.

Various relationships can thus exist between a given femto node and a given access terminal. For example, from the perspective of an access terminal, an open femto node can refer to a femto node with no restricted association. A restricted femto node can refer to a femto node that is restricted in some manner (e.g., restricted for association and/or registration). A home femto node can refer to a femto node on which the access terminal is authorized to access and operate on. A guest femto node can refer to a femto node on which an access terminal is temporarily authorized to access or operate on. An alien femto node can refer to a femto node on which the access terminal is not authorized to access or operate on (e.g., the access terminal is a non-member), except for perhaps emergency situations (e.g., 911 calls).

From a restricted femto node perspective, a home access terminal can refer to an access terminal that authorized to access the restricted femto node. A guest access terminal can refer to an access terminal with temporary access to the restricted femto node. An alien access terminal can refer to an access terminal that does not have permission to access the restricted femto node, except for perhaps emergency situations, for example, 911 calls (e.g., an access terminal that does not have the credentials or permission to register with the restricted femto node).

For convenience, the disclosure herein describes various functionality in the context of a femto node. It should be appreciated, however, that a pico node can provide the same or similar functionality as a femto node, but for a larger coverage area. For example, a pico node can be restricted, a home pico node can be defined for a given access terminal, and so on.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of routing network communications, comprising:
communicating with a device in a local area network (LAN) over a LAN communications port;
communicating with a wide-area network modem over a modem communications port; and
routing packets between the LAN communications port and the modem communications port through a module over a plurality of virtual LAN (VLAN) ports.

2. The method of claim 1, further comprising receiving communications from one or more mobile devices over a radio interface at the module, wherein the communicating with the wide-area network modem comprises routing the communications from the module over the modem communications port using at least one of the plurality of VLAN ports associated with the modem communications port.

3. The method of claim 2, further comprising prioritizing the communications received from the one or more mobile devices for routing over the modem communications port above other communications received over the LAN communications port.

4. The method of claim 3, wherein the prioritizing is based in part on providing a quality-of-service associated with the communications.

5. The method of claim 1, further comprising:
receiving local internet protocol access (LIPA) communications from the one or more mobile devices over a radio interface at the module; and
routing the LIPA communications from the module over a LIPA communications port using an associated LIPA VLAN port.

6. The method of claim 1, further comprising:
receiving local internet protocol access (LIPA) communications over a LIPA communications port; and
routing the LIPA communications to the module using a LIPA VLAN port associated with the LIPA communications port.

7. The method of claim 1, further comprising dropping one or more packets at the module received from the modem communications port and intended for the device in the LAN to provide a quality-of-service for one or more mobile devices communicating with the module.

8. An apparatus for routing network communications, comprising:
at least one processor configured to:
communicate with a device in a local area network (LAN) over a LAN communications port;
communicate with a wide-area network modem over a modem communications port; and
route packets between the LAN communications port and the modem communications port through a module over a plurality of virtual LAN (VLAN) ports; and
a memory coupled to the at least one processor.

9. The apparatus of claim 8, wherein the at least one processor is further configured to receive communications from one or more mobile devices over a radio interface at the module, and wherein the at least one processer routes the communications from the module over the modem communications port using at least one of the plurality of VLAN ports associated with the modem communications port.

10. The apparatus of claim 9, wherein the at least one processor is further configured to prioritize the communications received from the one or more mobile devices for routing over the modem communications port above other communications received over the LAN communications port.

11. The apparatus of claim 10, wherein the at least one processor prioritizes based in part on providing a quality-of-service associated with the communications.

12. The apparatus of claim 8, wherein the at least one processor is further configured to:
receive local internet protocol access (LIPA) communications from the one or more mobile devices over a radio interface at the module; and
route the LIPA communications from the module over a LIPA communications port using an associated LIPA VLAN port.

13. The apparatus of claim 8, wherein the at least one processor is further configured to:
receive local internet protocol access (LIPA) communications over a LIPA communications port; and
route the LIPA communications to the module using a LIPA VLAN port associated with the LIPA communications port.

14. The apparatus of claim 8, wherein the at least one processor is further configured to drop one or more packets at the module received from the modem communications port and intended for the device in the LAN to provide a quality-of-service for one or more mobile devices communicating with the module.

15. An apparatus for routing network communications, comprising:
means for communicating with a device in a local area network (LAN) over a LAN communications port;
means for communicating with a wide-area network modem over a modem communications port; and
means for routing packets between the LAN communications port and the modem communications port through a module over a plurality of virtual LAN (VLAN) ports.

16. The apparatus of claim 15, further comprising means for receiving communications from one or more mobile devices over a radio interface at the module,
wherein the means for routing routes the communications from the module over the modem communications port using at least one of the plurality of VLAN ports associated with the modem communications port.

17. The apparatus of claim 16, further comprising means for prioritizing the communications received from the one or more mobile devices at the module for routing over the modem communications port above other communications received over the LAN communications port.

18. The apparatus of claim 17, wherein the means for prioritizing prioritizes based in part on providing a quality-of-service associated with the communications.

19. The apparatus of claim 15, further comprising means for receiving local internet protocol access (LIPA) communications from the one or more mobile devices over a radio interface at the module, wherein the means for routing routes the LIPA communications from the module over a LIPA communications port using an associated LIPA VLAN port.

20. The apparatus of claim 15, further comprising means for receiving local internet protocol access (LIPA) communications over a LIPA communications port, wherein the means for routing routes the LIPA communications to the module using a LIPA VLAN port associated with the LIPA communications port.

21. The apparatus of claim 15, wherein the module drops one or more packets received from the modem communications port and intended for the device in the LAN to provide a quality-of-service for one or more mobile devices communicating with the module.

22. A computer program product for routing network communications, comprising:
a computer-readable medium, comprising:
code for causing at least one computer to communicate with a device in a local area network (LAN) over a LAN communications port;
code for causing the at least one computer to communicate with a wide-area network modem over a modem communications port; and
code for causing the at least one computer to route packets between the LAN communications port and the modem communications port through a module over a plurality of virtual LAN (VLAN) ports.

23. The computer program product of claim 22, wherein the computer-readable medium further comprises code for causing the at least one computer to receive communications from one or more mobile devices over a radio interface at the module, wherein the code for causing the at least one computer to route routes the communications from the module over the modem communications port using at least one of the plurality of VLAN ports associated with the modem communications port.

24. The computer program product of claim 23, wherein the computer-readable medium further comprises code for causing the at least one computer to prioritize the communications received from the one or more mobile devices for routing over the modem communications port above other communications received over the LAN communications port.

25. The computer program product of claim 24, wherein the code for causing the at least one computer to prioritize prioritizes based in part on providing a quality-of-service associated with the communications.

26. The computer program product of claim 22, wherein the computer-readable medium further comprises:
code for causing the at least one computer to receive local internet protocol access (LIPA) communications from the one or more mobile devices over a radio interface at the module; and
code for causing the at least one computer to route the LIPA communications from the module over a LIPA communications port using an associated LIPA VLAN port.

27. The computer program product of claim 22, wherein the computer-readable medium further comprises:
code for causing the at least one computer to receive local internet protocol access (LIPA) communications over a LIPA communications port; and
code for causing the at least one computer to route the LIPA communications to the module using a LIPA VLAN port associated with the LIPA communications port.

28. The computer program product of claim 22, wherein the computer-readable medium further comprises code for causing the at least one computer to drop one or more packets at the module received from the modem communications port and intended for the device in the LAN to provide a quality-of-service for one or more mobile devices communicating with the module.

29. An apparatus for routing network communications, comprising:
a local area network (LAN) communications port for communicating with a device in a LAN;
a modem communications port for communicating with a wide-area network modem; and
a switching component for routing packets between the LAN communications port and the modem communications port through a femtocell modem component over a plurality of virtual LAN (VLAN) ports.

30. The apparatus of claim 29, wherein the femtocell modem component receives communications from one or more mobile devices over a radio interface, and wherein the switching component routes the communications from the femtocell modem component over the modem communications port using at least one of the plurality of VLAN ports associated with the modem communications port.

31. The apparatus of claim 30, further comprising a packet routing component that prioritizes the communications received from the one or more mobile devices at the femtocell modem component for routing over the modem communications port above other communications received over the LAN communications port.

32. The apparatus of claim 31, wherein the packet routing component prioritizes based in part on providing a quality-of-service associated with the communications.

33. The apparatus of claim 29, further comprising a local internet protocol access (LIPA) communications port for receiving LIPA communications from the one or more mobile devices over a radio interface at the femtocell modem component, wherein the switching component routes the LIPA communications from the femtocell modem component over a LIPA communications port using an associated LIPA VLAN port.

34. The apparatus of claim 29, further comprising a local internet protocol access (LIPA) communications port for receiving LIPA communications, wherein the switching component routes the LIPA communications to the femtocell modem component using a LIPA VLAN port associated with the LIPA communications port.

35. The apparatus of claim 29, wherein the femtocell modem component drops one or more packets received from the modem communications port and intended for the device in the LAN to provide a quality-of-service for one or more mobile devices communicating with the module.
